(19) United States
(12) Patent Application Publication
(10) Pub. No.: US 2026/0039456 A1
(43) Pub. Date: Feb. 5, 2026

(54) SECURE COMMUNICATION

(71) Applicant: University of Leeds, Leeds (GB)

(72) Inventors: Benjamin Thomas Hornsby VARCOE, Leeds, Yorkshire (GB); George BRUMPTON, Leeds, Yorkshire (GB); Mark CARNEY, London (GB); Freya Louise WILSON, Pudsey (GB)

(73) Assignee: University of Leeds, Leeds (GB)

(21) Appl. No.: 19/099,254

(22) PCT Filed: Jul. 7, 2023
(86) PCT No.: PCT/GB2023/051797

§ 371 Date: Jan. 28, 2025

(30) Foreign Application Priority Data
Jul. 28, 2022 (GB) 2211041.5

(51) Int. Cl. H04L 9/08; H04L 9/12

(52) U.S. Cl. CPC H04L 9/085; H04L 9/0861; H04L 9/12; H04L 2209/08

(57) ABSTRACT

“There is disclosed a method for deriving shared secret information between a first device (A) and a second device (B). The method comprises: obtaining, by device A, a data set D_{A}; and obtaining, by device B, a data set D_{B}. Then, for each of N subsets, D_{A}ⁱ and D_{B}ⁱ, respectively of D_{A} and D_{B} (i=1, 2, . . . , N; N>1) the following steps are carried out: determining, by device A, a first value, V_{A}ⁱ=M_{A}(D_{A}ⁱ) based on D_{A}ⁱ, wherein M_{A} comprises an entropy-reducing function and/or a statistical function; determining, by device B, a second value, V_{B}ⁱ=M_{B}(D_{B}ⁱ) based on D_{B}ⁱ, wherein M_{B} comprises an entropy-reducing function and/or a statistical function; and exchanging one or more messages between devices A and B to determine whether a condition based on the first and second values, V_{A}ⁱ and V_{B}ⁱ, is satisfied.”

### BACKGROUND

### Field

Certain examples of the present disclosure provide one or more techniques for deriving shared secret information between two or more devices. Certain examples of the present disclosure provide one or more techniques for performing a secure operation, for example secure communication, using the shared secret information.

### Description of the Related Art

A fundamental problem in communication theory is how to transmit a message, M, between two parties without a third party also being able to obtain the message. For example, in the field of electronic financial transactions, it is very important to maintain secrecy in the communication between two parties.

Conventionally, the two parties who wish to exchange a message are known respectively as Alice (A) and Bob (B), while an eavesdropper who wishes to gain unauthorised access to the message M is known as Eve (E).

Many communication techniques have been developed to solve this problem. One class of techniques relies on the computational limitations of Eve that prevent her from performing certain mathematical operations in a reasonable time. For example the security of the RSA public key cryptographic technique relies heavily on the computational difficulty in factoring very large integers. Techniques of this type are known as “conditionally secure” or “computationally secure”.

One problem with conditionally secure techniques is that confidence in their security relies on mathematical results in the field of complexity theory that remain unproven. Therefore, it cannot, at present, be certain that such techniques will not be broken in the future, using only the resources of a classical computer, if appropriate mathematical tools for doing so can be developed. Furthermore, the development of quantum computational techniques renders conditionally secure techniques vulnerable due to the potential ability of quantum computers to perform certain mathematical operations, including operations on which computationally secure techniques rely, much faster than a classical computer.

Therefore, there has been a great deal of interest in the development of a class of communication techniques that makes no assumptions about the computing power of Eve. Techniques of this type are known as “unconditionally secure”.

One example of an unconditionally secure data transmission scheme is known as the “one-time pad”. According to this technique, Alice bitwise modulo-2 adds (i.e. XORs) a binary plaintext string (the message M) and a secret random binary string (the one-time pad) having the same length as the message. The resulting binary ciphertext string (the enciphered message M^{ε}) is transmitted to Bob instead of the original message M. To recover the original message M, Bob bitwise modulo-2 adds a local copy of the one-time pad to the received enciphered message M^{ε}. Even if Eve intercepts the transmitted enciphered message M^{ε}, it is impossible for Eve to recover the original message M without knowledge of the one-time pad. As suggested by the name, the one-time pad is used only once to help preserve security.

A fundamental requirement of any secure communication scheme is that Alice and/or Bob must possess some kind of secret information that is unknown to Eve. This secret information is used as the basis of the encryption and/or subsequent decryption of a message. In some schemes, it is necessary for both Alice and Bob to possess at least some secret information that is at least partially shared between them. For example, the secret information may be in the form of the random binary string in the one-time pad scheme described above. In this case, the secret information is fully shared between Alice and Bob.

In various techniques, shared secret information is first distributed between Alice and Bob using a first mechanism, and then Alice and Bob use a second mechanism involving the shared secret information to exchange a message. One reason why this two-stage approach is used, rather than to simply directly exchange the message using the first mechanism, is that mechanisms suitable for allowing Alice and Bob to obtain shared secret information without prior shared information may be unsuitable or impractical for message exchange in some cases. For example, some mechanisms allow Alice and Bob to obtain shared secret information, but do not allow Alice and Bob to control the exact content of the shared secret information.

One problem with any secure communication technique requiring shared secret information is how to distribute the secret information between Alice and Bob without it becoming known to Eve. This problem can be especially acute in the case of techniques such as the one-time pad, in which the amount of secret information required is comparable to the amount of plaintext message data. Therefore, what is desired is a technique that allows Alice and Bob to obtain shared secret information.

The above information is presented as background information only to assist with an understanding of the present disclosure. No determination has been made, and no assertion is made, as to whether any of the above might be applicable as prior art with regard to the present disclosure.

### SUMMARY

It is an aim of certain examples of the present disclosure to address, solve, mitigate or obviate, at least partly, at least one of the problems and/or disadvantages associated with the related art, for example at least one of the problems and/or disadvantages mentioned herein. Certain examples of the present disclosure aim to provide at least one advantage over the related art, for example at least one of the advantages mentioned herein.

The present invention is defined in the independent claims. Advantageous features are defined in the dependent claims.

Embodiments, aspects or examples disclosed in the description and/or figures falling outside the scope of the claims are to be understood as examples useful for understanding the present invention.

Other aspects, advantages, and salient features of the present disclosure will become apparent to those skilled in the art from the following detailed description, which, taken in conjunction with the accompanying drawings, disclose examples of the present disclosure.

### BRIEF DESCRIPTION OF THE FIGURES

FIG. 1 illustrates the relationship between various quantities related to three random variables X, Y and Z;

FIG. 2 is a flow chart of an exemplary method for deriving shared secret information between a first device (device A) and a second device (device B);

FIG. 3 illustrates an example of deriving reduced data sets based on data sets;

FIG. 4 is a message flow diagram of a first exemplary technique for deriving shared secret information;

FIG. 5 is a message flow diagram of a second exemplary technique for deriving shared secret information; and

FIG. 6 is a block diagram of an exemplary device for deriving secret information shared with another device.

### DETAILED DESCRIPTION

The following description of examples of the present disclosure, with reference to the accompanying drawings, is provided to assist in a comprehensive understanding of the present invention, as defined by the claims. The description includes various specific details to assist in that understanding but these are to be regarded as merely exemplary. Accordingly, those of ordinary skill in the art will recognize that various changes and modifications of the examples described herein can be made.

Certain examples of the present disclosure provide one or more techniques for deriving shared secret information between two or more devices (or apparatus). Certain examples of the present disclosure provide one or more techniques for performing a secure operation, for example secure communication, using the shared secret information.

A device capable of implanting one or more techniques described herein may be of any suitable type, for example a mobile device (such as a mobile telephone), a computer terminal, a relay device, a server, a node in a network (such as the Internet or a private network) or any other suitable type of device for communicating. Furthermore, such a device may be a manually operated device (e.g. one operated by a user), or may be a device that is partially or fully automated. In certain examples, one or more more of the techniques described herein may be applied to communication between internal components of one or more devices. Accordingly, references herein to a ‘device’ that communicates with another device may also include references to an internal component of a device that communicates with another internal component of either the same device or a different device.

The techniques described herein may be used in a wide variety of different applications, including, but not limited to, financial transactions, Police, Armed Forces, Government, mobile data, mobile voice, navigation and location information (e.g. GPS), financial services, banking, shipping communications, subscriber services, mobile security services, distributed networking, remote access, Internet communications, virtual private networks, satellite communications, remote command and control systems, aircraft (e.g. drone aircraft), remote control, data storage and archiving, and identity management and security. The skilled person will appreciate that shared secret information obtained using one or more techniques described herein may be used in any suitable type of secure operation, not limited to secure communication.

The skilled person will appreciate that the techniques described herein may be used to enable a set of two or more devices to obtain shared secret information (i.e. obtain information that is known to those devices but not to any other entity). In certain examples, the techniques may be used by devices A and B to obtain first shared secret information (shared between A and B). In certain examples, the techniques may be also used by devices A and C to obtain second shared secret information (shared between A and C). In certain examples, the techniques may be used by a set of three or more devices {A, B, C, . . . } to obtain third shared secret information (shared between {A, B, C, . . . }).

Before proceeding with the following description, certain useful concepts in the field of information theory will now be briefly described.

Consider a discrete random variable, X, characterised by the probability distribution function P_{X}. The entropy H of X is defined by:

$$H ( X ) = - {\sum }_{x ∈ X} {P}_{x} ( x ) {log}_{b} ( {P}_{x} ( x ) ) \qquad Eq . 1$$

In Equation 1, x denotes a particular outcome of X, P_{X}(x) is the probability of outcome x, and b is an arbitrary logarithmic base which determines the unit of the entropy. Frequently, the base b is chosen to be 2, in which case the unit of entropy is “bits”. The entropy of X may be regarded as a measure of the uncertainty associated with outcomes of X. One interpretation is that the entropy (in bits) gives the average number of yes/no type questions needed to guess an outcome of X, when using an optimum guessing strategy, and is the average number of bits per outcome needed to encode a sequence of outcomes of X.

The conditional entropy H(X|Y) for discrete random variables X and Y is defined by:

$$H ( X \vert Y ) = {\sum }_{y ∈ Y} {P}_{Y} ( Y ) [ - {\sum }_{x ∈ X} {P}_{X \vert Y} ( x \vert y ) {log}_{b} ( {P}_{X \vert Y} ( x \vert y ) ) ] = - {\sum }_{{x ∈ X}_{y ∈ Y}} {P}_{XY} ( x , y ) {log}_{b} ( {P}_{X \vert Y} ( x \vert y ) ) \qquad Eq . 2$$

In Equation 2, x and y denote, respectively, particular outcomes of X and Y, P_{X}(x) and P_{Y}(y) are the probabilities, respectively, of outcomes x and y, P_{X|Y}(x|y) is the conditional probability of outcome x given outcome y, P_{XY}(x,y) is the joint probability distribution of X and Y, and b is an arbitrary logarithmic base. The conditional entropy H(X|Y) may be interpreted as a measure of the uncertainty in X after observing Y.

The mutual information |(X;Y) for discrete random variables X and Y is defined by:

$$I ( X ; Y ) = {\sum }_{{x ∈ X}_{y ∈ Y}} {P}_{XY} ( x , y ) {log}_{b} \frac{{P}_{XY} ( x , y )}{{P}_{X} ( x ) {P}_{Y} ( y )} = H ( X ) - H ( X \vert Y ) \qquad Eq . 3$$

In Equation 3, x and y denote, respectively, particular outcomes of X and Y, P_{X}(x) and P_{Y}(y) are the probabilities, respectively, of outcomes x and y, P_{XY}(x,y) is the joint probability distribution of X and Y, and b is an arbitrary logarithmic base.

From Equation 3, it can be seen that the mutual information |(X;Y) may be interpreted as the reduction in uncertainty in X after observing Y. Equivalently, the mutual information |(X;Y) may be interpreted as the amount of information gained about X after observing Y, or as the amount of information shared between X and Y. If X and Y are relatively highly correlated, then the mutual information |(X;Y) will be relatively high. Conversely, if X and Y are relatively lowly correlated, then the mutual information |(X;Y) will be relatively low. If X and Y are totally uncorrelated then |(X;Y)=0 while if X=Y then |(X;Y)=H(X). Mutual information is symmetric in its arguments: |(X;Y)=|(Y;X).

As an example, in the one-time pad scheme described above, the mutual information between the message M and the enciphered message M^{ε} is equal to zero, /(M;M^{ε})=0. Thus, Eve gains no information about the message M from the enciphered message M^{ε}. It is this property which makes the one-time pad scheme described above unconditionally secure as long as the one time pad remains secret.

The definitions of conditional entropy and mutual information given above may be extended to consider more than two discrete random variables. For example, in the case of three discrete random variables X, Y and Z, the conditional entropy H(X|YZ) may be interpreted as the uncertainty in X after observing Y and Z. The mutual information |(X;Y;Z) may be interpreted as the information shared between X, Y and Z. The mutual information |(X;Y|Z) may be interpreted as the information shared between X and Y that is not shared with Z.

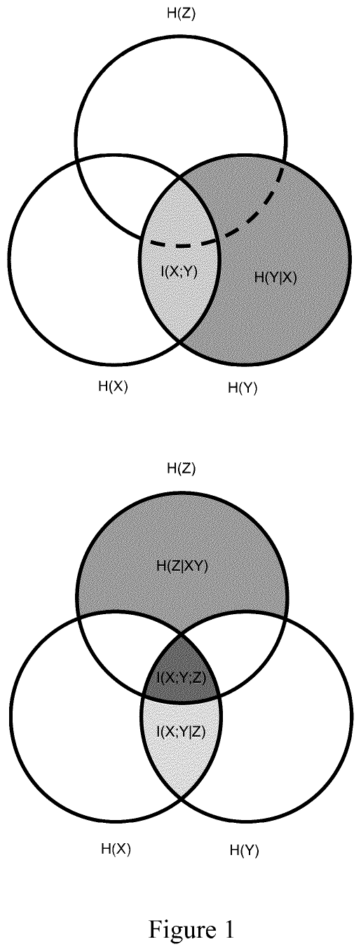

The relationships between various quantities related to random variables can be represented schematically by a venn-type diagram. For example, FIG. 1 illustrates the relationship between various quantities related to three random variables X, Y and Z. The three overlapping circles represent H(X), H(Y) and H(Z), respectively. The quantities |(X;Y), H(Y|X), H(Z|XY), |(X;Y|Z) and |(X;Y;Z) are indicated by shaded regions. The areas representing the conditional entropy and mutual information for other combinations of variables in FIG. 1 can be deduced by symmetry.

Various exemplary techniques for deriving shared secret information between a first device and a second device will now be described. In the following examples, the first device may be referred to as device A (Alice) and the second device may be referred to as device B (Bob). However, the skilled person will appreciate that these labels are merely exemplary.

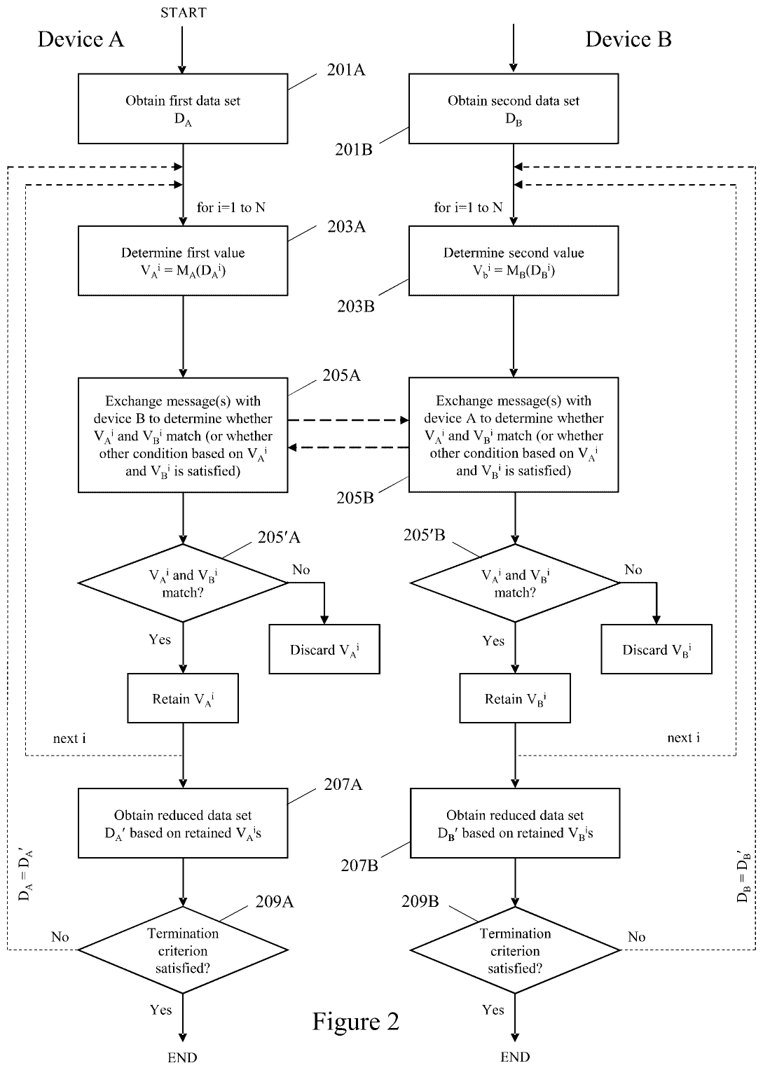

FIG. 2 is a flow chart of an exemplary technique for deriving shared secret information between device A and device B. The left hand side of FIG. 2 illustrates operations carried out by device A and the right hand side of FIG. 2 illustrates operations carried out by device B.

In this technique, devices A and B separately obtain respective non-identical data sets (e.g. bit sequences). Then, by performing various operations and message exchanges, each device derives respective reduced data sets including by selectively discarding and retaining certain elements of the original data sets, such that the reduced data sets tend to comprise a higher proportion of matching elements (e.g. matching bits) than the original data sets. The decisions about which elements to discard and retain are made based on computing an entropy-reducing function or a statistical function (e.g. a parity fuction) of subsets of the data sets.

A statistical function may comprise a function in which the output comprises statistical information based on the input. For example, a statistical function may be regarded as a function in which the output ‘summarises’ the input in some respect. An entropy-reducing function may comprise a function that reduces the information content, or entropy, of the input to generate the output. For example, the information content or entropy may be defined in accordance with any suitable known definition used in information theory. An entropy-reducing function may be regarded as a function in which the output has a lower complexity than the input. In certain examples, a statistical function may be regarded as a type of entropy-reducing function. However, in other examples, the output of a statistical function does not necessarily have a lower entropy than the input, depending on the definitions used. The use of an entropy-reducing function or a statistical function reduces the amount of information about the data sets revealed to a potential eavesdropper.

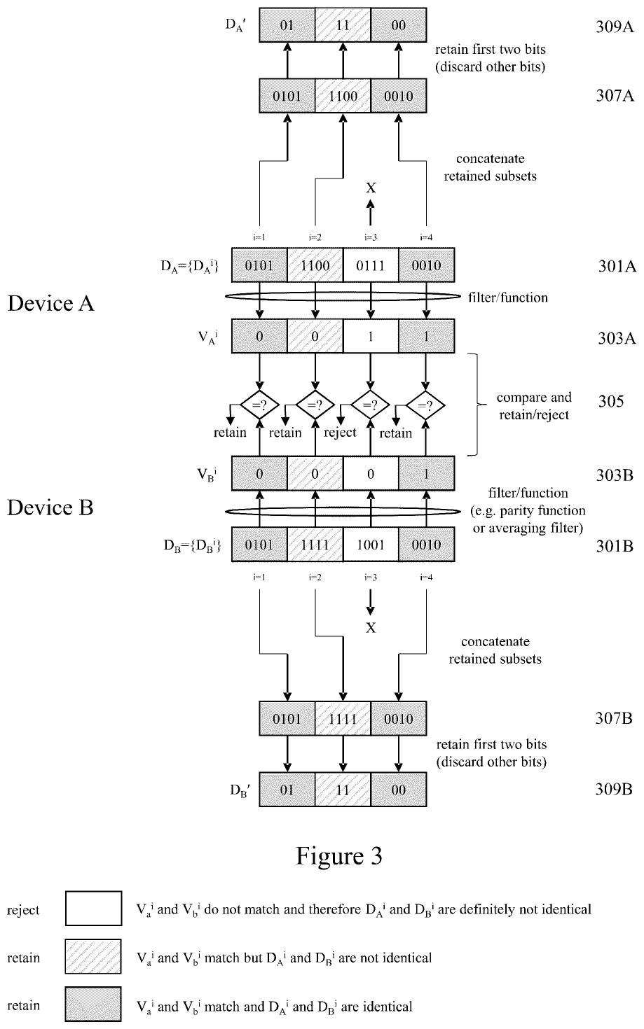

FIG. 3 illustrates an example of deriving reduced data sets from data sets.

These steps will now be described in greater detail with reference to FIGS. 2 and 3.

In step 201A, device A obtains a first data set D_{A}.

In a corresponding step 201B, device B obtains a second data set D_{B}.

The data sets, D_{A} and D_{B} may each comprise an indexable set of elements, where each element may take one of two or more values. For example, the data sets, D_{A} and D_{B}, may each comprise data sequences (e.g. bit sequences).

The data sets D_{A} and D_{B} may each comprise a random data set. However, in other examples, the data sets may be non-random.

The data sets, D_{A} and D_{B}, may be non-identical. However the data sets should comprise at least some matching elements (e.g. at least some elements of D_{A} have the same value as the corresponding elements of D_{B} at the same index value). For example, in the case that the data sets comprise sequences of bits the bit values of D_{A} an D_{B} match at at least some bit positions. In this case, there is at least some information overlap between the data sets: I(D_{A}; D_{B})>0. Certain techniques described herein aim to increase the information overlap, for example until the data sets are identical or differ by less than a certain threshold.

The data sets D_{A} and D_{B} should remain confidential (i.e. remain unknown to unauthorised parties, such as a potential eavesdropper).

Devices A and B may obtain the data sets D_{A} and D_{B} using any suitable technique. For example, a random data set may be generated based on a pseudorandom number generator. In other examples, a random data set may be obtained based on one or more natural sources of randomness. For example, a known data set may be encoded into a signal and then the signal may be transmitted through a noisy communication channel to a device. The device may then compare the known data set with the data set obtained from the received signal to obtain an error signal that forms the data set. Alternatively or additionally, a random data set may be obtained by sampling random noise of an electronic component. In certain examples, a non-random data set may be obtained by sampling an audio signal (e.g. obtained using a microphone) and/or an image signal (e.g. obtained using an imaging device). In another example, a non-random data set may comprise a predetermined data set.

In the following, it is assumed that the data sets D_{A} and D_{B} comprise sequences of bits. However, the skilled person will appreciate that the techniques described herein apply to other types of data sets.

FIG. 3 illustrates an exemplary data set D_{A} 301A comprising a 16-bit sequence [0101 1100 0111 0010] and an exemplary data set D_{B} 301B comprising a 16-bit sequence [0101 1111 1001 0010].

Following steps 201A and 201B, various steps are carried out as described below to derive, from data sets D_{A} and D_{B}, respective reduced data sets D_{A}′ and D_{A}′, comprising a higher proportion of matching elements (e.g. matching bits) than data sets D_{A} and D_{B}. In particular, subsets of D_{A} and corresponding subsets of D_{B} are considered individually. An entropy-reducing function or a statistical function is computed based on each subset, and elements of D_{A} and D_{B} are discarded or retained based on the results. These steps will now be described in more detail.

For each of N subsets, D_{A}ⁱ and D_{B}ⁱ, respectively of D_{A} and D_{B}(i=1, 2, . . . , N; N>1), the following steps 203A, 203B, 205A (including 205′A) and 205B (including 205′B) are carried out. This repetition is illustrated in FIG. 2 as the loop “for i=1 to N” and “next i” indicated with a dotted line. Each repetition of the loop corresponds to processing of a single pair of corresponding subsets DAi and D_{B}ⁱ with a certain index value i (i=1, 2, . . . , N; N>1).

The N subsets, D_{A}ⁱ and D_{B}ⁱ, may each comprise mutually exclusive subsets of D_{A} and D_{B}, respectively. For example, the N subsets, D_{A}ⁱ and D_{B}ⁱ, may each comprise a set of n (e.g. n=4) data elements (e.g. consecutive bits) of D_{A} and D_{B}, respectively. Corresponding subsets of D_{A} and D_{B} may comprise elements of the respective data sets having the same index. For example, first corresponding subsets may comprise the the first four (or any other suitable number) bits of D_{A} and D_{B}, second corresponding subset may comprise the next four bits D_{A} and D_{B}, and so on. In other examples, the bits of a subset need not comprise a contiguous set of bits. The subsets may comprise the same number of bits. However, in other examples, at least some subsets may have different sizes.

FIG. 3 illustrates each data set D_{A} 301A and D_{B} 301B divided into four exemplary subsets of four consecutive bits each. In this example, D_{A}¹=[0101], D_{A}²=[1100], D_{A}³=[0111] and D_{A}⁴=[0010] and D_{B}¹=[0101], D_{B}²=[1111], D_{B}³=[1001] and D_{B}⁴=[0010].

In step 203A, device A determines a first value, V_{A}ⁱ=M_{A}(D_{A}ⁱ) based on D_{A}ⁱ. In certain examples, M_{A} may comprise an entropy-reducing function or a statistical function. In certain examples, M_{A} may comprise a filtering function.

In a corresponding step 203B, device B determines a second value, V_{B}ⁱ=M_{B}(D_{B}ⁱ) based on D_{B}ⁱ . In certain examples, M_{B} may comprise an entropy-reducing function or a statistical function. In certain examples, M_{B} may comprise a filtering function.

M_{A} may be the same function as M_{B}. For example, M_{A} and/or M_{B} may comprise one or more of: parity function, Hamming distance function, mean function, and variance function. When applied to bit sequences, these functions may be defined as follows.
Given an ith subset D_{A}ⁱ=[a₀, a₁, . . . , aⱼ, . . . , aₙ], aⱼ ∈ {0,1}, the parity value of D_{A}ⁱ may be defined as:

$${M}_{A} ( {D}_{A}^{i} ) = ( {\sum }_{j = 0}^{n} {a}_{j} ) Mod ( 2 )$$

Given an ith subset D_{A}ⁱ=[a₀, a₁, . . . , aⱼ, . . . , aₙ], aⱼ ∈ {0,1}, and given a code Bⁱ=[b₀, b₁, . . . , bⱼ, . . . , bₙ], bⱼ ∈ {0,1}, the Haming Distance (HD) of D_{A}ⁱ with respect to Bi may be defined as:

$$HD ( {D}_{A}^{i} , {B}^{i} ) = {\sum }_{j = 0}^{n} ( ( {a}_{j} + {b}_{j} ) Mod ( 2 ) )$$

For example, the code Bⁱ may be a one-time code comprising random bits defined for the ith subset.

A two-part value may be defined as M_{A} (D_{A}ⁱ)=[HD(D_{A}ⁱ, Bⁱ), Bⁱ]
Given an ith subset D_{A}ⁱ=[a₀, a₁, . . . , aⱼ, . . . , aₙ], aⱼ ∈ {0,1}, the mean value of D_{A}ⁱ may be defined as:

$${M}_{A} ( {D}_{A}^{i} ) = \frac{1}{n} ( {\sum }_{j = 0}^{n} {a}_{j} ) = \overline{a}$$

Given an ith subset D_{A}ⁱ=[a₀, a₁, . . . , aⱼ, . . . , aₙ], aⱼ ∈ {0,1}, the variance value of D_{A}ⁱ may be defined as:

$${M}_{A} ( {D}_{A}^{i} ) = \frac{1}{n - 1} {\sum }_{j = 0}^{n} {( {a}_{j} = \overline{a} )}^{2}$$

The function M_{B} (D_{A}ⁱ) in each of the above examples may be defined similarly.

FIG. 3 illustrates an example in which the values V_{A}ⁱ 303A are derived from the subsets D_{A}ⁱ 310A, and in which the values V_{B}ⁱ 303B are derived from the subsets D_{B} 301B, using a partiy function. For example:

$$\begin{matrix}{D}_{A}^{1} = [ 0101 ] \to {V}_{A}^{1} = [ 0 ] & {D}_{B}^{1} = [ 0101 ] \to {V}_{B}^{1} = [ 0 ] \\ {D}_{A}^{2} = [ 1100 ] \to {V}_{A}^{2} = [ 0 ] & {D}_{B}^{2} = [ 1111 ] \to {V}_{B}^{2} = [ 0 ] \\ {D}_{A}^{3} = [ 0111 ] \to {V}_{A}^{3} = [ 1 ] & {D}_{B}^{3} = [ 1001 ] \to {V}_{B}^{3} = [ 0 ] \\ {D}_{A}^{4} = [ 0010 ] \to {V}_{A}^{4} = [ 1 ] & {D}_{B}^{4} = [ 0010 ] \to {V}_{B}^{4} = [ 1 ]\end{matrix}$$

The functions M_{A} and M_{B} may be chosen such that the input values cannot be determined from the output value. That is, D_{A}ⁱ cannot be determined from M_{A}(D_{A}ⁱ) and Dei cannot be determined from M_{B}(D_{B}ⁱ). For example, each of M_{A} and M_{B} may be defined such that multiple inputs map to the same output. This property allows confidentiality to be maintained since a potential eavesdropper cannot gain complete knowledge of D_{A}ⁱ and Dei based on M_{A}(D_{A}ⁱ) and M_{B}(D_{A}ⁱ).

In addition, the functions may be chosen such that if M_{A}(D_{A}ⁱ)≠M_{B}(D_{B}ⁱ) then D_{A}ⁱ≠D_{B}ⁱ. That is, if the output values based on two subsets are different, then this means that the two subsets are not identical. For example, each of M_{A} and M_{B} may be defined such that two different outputs cannot map to the same input. This property allows devices A and B to identify corresponding subsets D_{A}ⁱ and D_{B}ⁱ that definitely do not match. Such subsets may then be discarded in order to increase the probability of matches between the remaining subsets.

In steps 205A and 205B, devices A and B exchange one or more messages to determine whether a condition based on the first and second values, V_{A}ⁱ and V_{B}ⁱ, is satisfied. For example, if the functions M_{A} and M_{B} are the same then the condition may be determining whether V_{A}ⁱ=V_{B}ⁱ (illustrated separately as steps 205′A and 205′B in FIG. 2). In cases where the functions M_{A} and M_{B} are different then the condition may be modified accordingly. For example, if M_{A} is defined as “the number of 1's in a subset” and M_{B} is defined as “the number of 0's in a subset” then the condition may be determining whether V_{A}ⁱ=size−V_{B}ⁱ, where “size” is the number of bits in a subset.

In one example, exchanging the messages and determining whether the condition is satisfied may comprise the following steps. First, device A may transmit, to device B, the first value, V_{A}ⁱ, and device B may transmit, to device A, the second value, V_{B}ⁱ. Then, since each of devices A and B knows both V_{A}ⁱ and V_{B}ⁱ, each of devices A and B may determine whether the condition is satisfied based on a comparison between the first and second values, V_{A}ⁱ and V_{B}ⁱ.

In another example, exchanging the messages and determining whether the condition is satisfied may comprise the following steps. First, one of the devices A and B (device X) may transmit, to the other one of the devices A and B (device Y), the value V_{X}ⁱ. Next, device Y, which knows both V_{X}ⁱ and V_{Y}ⁱ, may compare the values V_{X}ⁱ and V_{Y}ⁱ. Then, device Y may transmit, to device X, a value Cⁱ indicating the result of the comparison (e.g. Cⁱ=0 denoting “no match” or Cⁱ=1 denoting “match”).

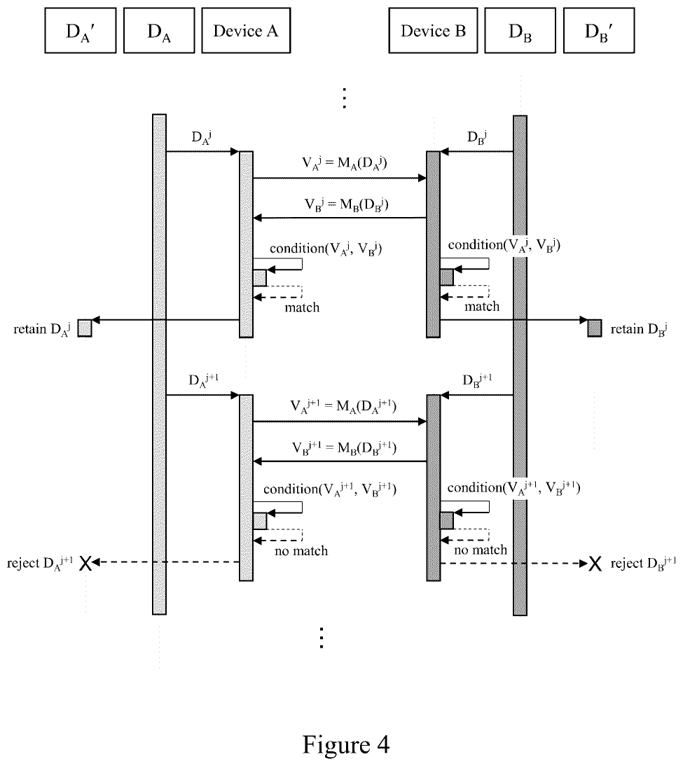

In the example of FIG. 2, each iteration of the loop corresponds to processing of a single pair of corresponding subsets D_{A}ⁱ and D_{B}ⁱ. In this case, the steps are carried out in the order {203A/B then 205A/B}ⁱ where {X}ⁱ here denotes repeating X i times. Here, steps 205′A/B are considered to be a part of steps 205A/B. FIG. 4 is a message flow diagram corresponding to this case.

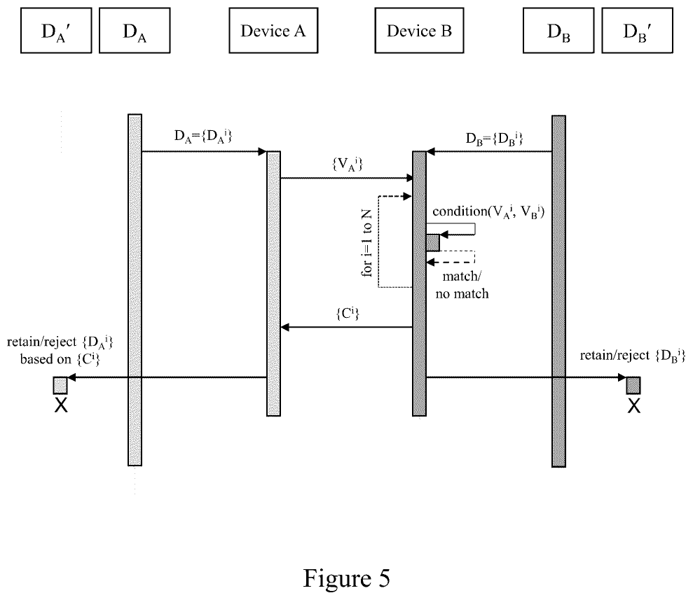

In certain alternative examples, the steps may be carried out in a different order. For example, steps 203A/B may be repeatedly carried out for all pairs of corresponding subsets D_{A}ⁱ and D_{B}ⁱ and then steps 205A/B may be repeatedly carried out for all pairs of corresponding subsets. In this case, the steps are carried out in the order {203A/B}ⁱ then {205A/B}ⁱ. In this case, information relating to different subsets communicated in steps 205A/B may be combined within a single message. For example: values of V_{A}ⁱ for all values of i may be transmitted from device A to device B in a single message in the form of a list; values of V_{B}ⁱ for all values of i may be transmitted from device B to device A in a single message in the form of a list; and/or values of Cⁱ for all values of i may be transmitted from device Y to device X in a single message in the form of a list. FIG. 5 is a message flow diagram corresponding to this case.

Following the above steps, devices A and B have acquired information allowing them to determine which corresponding subsets D_{A}ⁱ and D_{B}ⁱ definitiely do not match (i.e. there is a zero probability of matching). For example, if M_{A} and M_{B} are the same function then subsets that definitely do not match are those for which V_{A}ⁱ≠V_{B}ⁱ. On the other hand, corresponding subsets D_{A}ⁱ and D_{B}ⁱ for which V_{A}ⁱ≠V_{B}ⁱ may not match either, but there is a non-zero probability that they do match. By discarding corresponding subset which definitiely do not match, while retaining corresponding subsets that have a non-zero probability of matching, the overall probability of matching between the data sets is increased, and the information overlap between the data sets tends to increase accordingly (i.e. I (D_{A}; D_{B}) increases).

As illustrated in FIG. 3, in step 305, the values of V_{A}ⁱ and V_{B}ⁱ are compared and the subsets D_{A}ⁱ and D_{B}ⁱ are retained or rejected depending on whether the values of V_{A}ⁱ and V_{B}ⁱ match or do not match. In the example of FIG. 3, the values V_{A}ⁱ and V_{B}ⁱ do not match for i=3 and therefore the subsets D_{A}ⁱ and D_{B}ⁱ for i=3 are rejected as it is known from the mismatch between the values (i.e. V_{A}³=[1] and V_{B}³=[0]) that the corresponding subsets (i.e. D_{A}³=[0111] and D_{B}³=[1001]) are definitely not identical. On the other hand, the values V_{A}ⁱ and V_{A}ⁱ do match for i=1, 2 and 4 and therefore the subsets D_{A}ⁱ and D_{B}ⁱ for i=1, 2 and 4 are retained as the matching values V_{A}ⁱ and V_{B}ⁱ indicate that there is a non-zero probability that the corresponding subsets D_{A}ⁱ and D_{B}ⁱ match. Among the subsets for which V_{A}ⁱ and V_{B}ⁱmatch, the corresponding subsets D_{A}ⁱ and D_{B}ⁱ match for i=1 and 4 but do not match for i=2. Although a pair of non-matching subsets (i.e. i=2) is retained, the rejection of a pair of definitely non-matching subsets (i.e. i=3) tends to increase the overall information overlap between the retained subsets.

When steps 203A, 203B, 205A and 205B have been carried out for each of the N subsets, c and D_{B}ⁱ, then steps 207A and 207B are carried out.

In step 207A, device A obtains a reduced data set D_{A}′ based on those subsets D_{A}ⁱ for which the above-mentioned condition is satisfied (i.e. the retained subsets).

In a corresponding step 207B, device B obtains a reduced data set D_{B}′ based on those subsets D_{B}ⁱ for which the above-mentioned condition is satisfied (i.e. the retained subsets).

Obtaining the reduced data set, D_{A}′, may comprise the following steps. First, for each subset, D_{X}ⁱ , for which the condition is satisfied, a corresponding subset, D_{X}ⁱ′, may be obtained based on D_{X}ⁱ. Then, the corresponding subsets, D_{X}ⁱ′, may be combined to generate the reduced data set, D_{X}′.

In certain examples, a corresponding data set, D_{X}ⁱ′, may comprise all elements of D_{X}ⁱ. For example, D_{X}ⁱ′ may be the same as D_{X}ⁱ.

In certain examples, a corresponding data set, D_{X}ⁱ′, may comprise a predetermined subset of elements of D_{X}ⁱ. For example, certain bits of D_{X}ⁱ′ at predetermined bit positions may be discarded, and the remaining bits may form D_{X}ⁱ′.

In certain examples, a corresponding data set, D_{X}ⁱ′, may comprise a function, S, of all elements of D_{X}ⁱ. For example, the function, S, may comprise a parity function. For example, the parity of the set of bits of D_{X}ⁱ may be computed, and the resulting single parity bit may form D_{X}ⁱ′.

In certain examples, a corresponding data set, D_{X}ⁱ′, may comprise a function, S, (e.g. parity function) of a predetermined subset of elements of D_{X}ⁱ. For example, certain bits of D_{X}ⁱ′ at predetermined bit positions may be discarded, the parity of the remaining bits may be computed, and the single parity bit may form D_{X}ⁱ′.

However, D_{X}ⁱ′ is derived from Dxi, the resulting D_{X}ⁱ′ may be combined in any suitable manner, for example by concatenation, interleaving or any other suitable technique, to form D_{X}ⁱ.

FIG. 3 illustrates the subsets D_{A}ⁱ retained by device A 307A and the subsets D_{B}ⁱretained by device B 307B. FIG. 3 also illustrates an example in which a reduced data set may be obtained by retaining the first two bits, and discarding the other bits, of each retained subset, and concatenating the retained bits to form the reduced data set. The reduced data set D_{A}ⁱ for device A is shown at 309A and the reduced data set D_{B} ⁱ for device B is shown at 309B. In an alternative example, the reduced data sets may simply comprise a concatenation of the retained subsets, as shown at 307A and 307B.

As noted above, since the reduced data sets D_{A}ⁱ and D_{B}ⁱ are derived by excluding definitely non-matching subsets of D_{A} and D_{B}, then the information overlap between D_{A}′ and D_{B}′ will tend to be higher than the information overlap between D_{A} and D_{B}, I(D_{A}′; D_{B}′)>I(D_{A}; D_{B}). However, D_{A}′ and D_{B}′ may still have one or more non-matching subsets since M(D_{A}ⁱ)=M(D_{B}ⁱ) does not guarantee D_{A}ⁱ=D_{B}ⁱ.

Accordingly, in certain examples, the above-mentioned process may be repeated to further tend to increase the information overlap. In particular, the steps of determining (steps 203A and 203B), exchanging (steps 205A and 205B) and obtaining a reduced data set (steps 207A and 207B) may be repeated one or more times until one or more termination criteria 209A, 209B are satisfied. When repeating these steps, the data sets D_{A}, D_{B} used in one iteration comprise the reduced data sets D_{A}′, D_{B}′ obtained in the preceding iteration. As shown in FIG. 2, in steps 209A/B, if the one or more termination criteria are not satisfied then the method returns to steps 203A/B, otherwise the method ends.

The termination criteria 209A, 209B may be chosen such that, following the termination of the process, the data sets (e.g. bit sequences) of devices A and B match, or are highly likely to match (e.g. the probability of matching is greater than a certain threshold). For example, the one or more termination criteria may comprise: the number of iterations has reached a predetermined threshold. In this case, the threshold may be determined based on theoretical calculations, experiment and/or simulation. For example, a threshold of 3 or 4 may be used in certain examples.

In certain applications, an exact match between the resulting data sets (e.g. bit sequences) of devices A and B may be required. On the other hand, in other applications, an exact match may not be required. For example, if the data sets of devices A and B are used as a one-time pad for subsequent communication of data then errors between the data sets will result in errors in the data. However, some errors may be acceptable for some application, for example if the data includes an error correction code.

Once the data sets (e.g. bit sequences) have been obtained using the above technique, they may be used to perform a secure operation, for example secure communication between devices A and B. For example, the data sets may be used as a one-time pad for transmitting data. In certain examples, if errors are detected in the transmitted data, then this may be interpreted as indicating that the data sets did not match exactly. In this case, the above process may be repeated. In some cases, a further iteration of the method may be performed based on the existing data sets. However, in other examples, the entire process may be repeated starting from the beginning.

The technique described above allows two devices to derive shared secret information between them. However, the technique may be extended to allow more than two devices to derive shared secret information between them. For example, similar to the two-device case, in the case of three devices, each device obtains a respective data set. Then, considering subsets of the data sets, the three devices exchange messages between each other to identify and discard those subsets that definitely do not match between all three devices. Then, similar to the two-device case, each of the three devices derives a reduced data set based on the remaining subsets. Similar to the two-device case, the process may be repeated until one or more termination criteria are satisfied.

Certain examples of the present disclosure may obtain shared data sets based on processing abstract data sets. In certain examples, the data sets (e.g. binary data sequences) may be obtained based on one or more signals (e.g. physical signals), such as an audio signal and/or a light/image signal. A signal (e.g. an audio signal and/or a light/image signal) obtained by device A (e.g. via a user uttering a predetermined phrase and/or by capturing an image of a predetermined object) may be broken down into packets (corresponding to the subsets described above) and each packet may be filtered to generate a filtered signal (corresponding to an entropy-reducing function or a statistical function applied to the packet). For example, an averaging filter may be applied to a packet. A similar process may be carried out by device B.

Then, comparisons between filtered packets of devices A and B may be performed and filtered packets may be selectively discarded or retained based on the comparison to obtain a “reduced signal” (e.g. an audio signal and/or a light/image signal). The process may then be repeated as described above. Processing of the signal may be performed digitally or through analog processing, for example using any suitable electronic components.

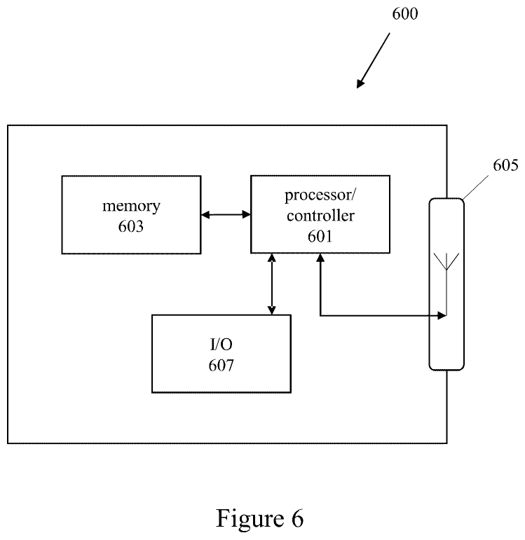

FIG. 6 illustrates an exemplary device (or apparatus) for deriving shared secret information and/or for communicating with another device. For example, the techniques disclosed in relation to FIGS. 2-5 may be implemented using a device as disclosed in relation to FIG. 6. For example, device A and device B may comprise a device as disclosed in relation to FIG. 6. The device 600 comprises a processor (or controller) 601 for controlling the overall operation of the device 600. For example, the processor 601 may be configured for performing operations as described above for deriving shared secret information. The device 600 also comprises a memory 603 for storing information and data required for the aforementioned operations. The device 600 also comprises an external interface 605 for communicating with another device via any suitable communication link (e.g. wired or wireless). For example, under the control of the processor 601, the external interface 605 may be configured to transmit and receive messages as described above.

In certain examples, the device 600 may also comprise a user input/output (I/O) unit 607 for allowing a user to interact with the device 600. For example, the user I/O unit 607 may comprise one or more input devices (e.g. a keyboard, touch screen, etc.) for inputting commands to the device 600. The user I/O unit 607 may comprise one or more output devices (e.g. display, LEDs, speaker, etc.) for outputting information (e.g. status information) for a user. In certain examples, if the device 600 is configured to operate autonomously, then the user I/O unit 607 may be omitted. In some examples, the device 600 may be configured to interface with another device in close proximity. In this case, the interface between the device 600 and the other device may be a wired link or a relatively short-range communication link such as a Bluetooth or NFC link. In other examples, the device 600 may be configured to interface with another device located remotely. In this case, the device 600 may communicate with the other device via a network, for example the Internet.

The terms and words used in this specification are not limited to the bibliographical meanings, but are merely used to enable a clear and consistent understanding of the present disclosure.

The same or similar components may be designated by the same or similar reference numerals, although they may be illustrated in different drawings.

Detailed descriptions of elements, features, components, structures, constructions, functions, operations, processes, characteristics, properties, integers and steps known in the art may be omitted for clarity and conciseness, and to avoid obscuring the subject matter of the present disclosure.

Throughout this specification, the words “comprises”, “includes”, “contains” and “has”, and variations of these words, for example “comprise” and “comprising”, means “including but not limited to”, and is not intended to (and does not) exclude other elements, features, components, structures, constructions, functions, operations, processes, characteristics, properties, integers, steps and/or groups thereof.

Throughout this specification, the singular forms “a”, “an” and “the” include plural referents unless the context dictates otherwise. For example, reference to “an object” includes reference to one or more of such objects.

By the term “substantially” it is meant that the recited characteristic, parameter or value need not be achieved exactly, but that deviations or variations, including for example, tolerances, measurement errors, measurement accuracy limitations and other factors known to those of skill in the art, may occur in amounts that do not preclude the effect the characteristic, parameter or value was intended to provide.

Throughout this specification, language in the general form of “X for Y” (where Y is some action, process, function, activity, operation or step and X is some means for carrying out that action, process, function, activity, operation or step) encompasses means X adapted, configured or arranged specifically, but not exclusively, to do Y.

Elements, features, components, structures, constructions, functions, operations, processes, characteristics, properties, integers, steps and/or groups thereof described herein in conjunction with a particular aspect, embodiment, example or claim are to be understood to be applicable to any other aspect, embodiment, example or claim disclosed herein unless incompatible therewith.

It will be appreciated that examples of the present disclosure can be realized in the form of hardware, software or any combination of hardware and software. Any such software may be stored in any suitable form of volatile or non-volatile storage device or medium, for example a ROM, RAM, memory chip, integrated circuit, or an optically or magnetically readable medium (e.g. CD, DVD, magnetic disk or magnetic tape).

Certain examples of the present disclosure provide a computer program comprising instructions which, when the program is executed by a computer or processor, cause the computer or processor to carry out a method according to any example, embodiment, aspect and/or claim disclosed herein. Certain examples of the present disclosure provide a computer or processor-readable data carrier having stored thereon such a computer program.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). An apparatus and/or one or more elements thereof may be implemented in the form of hardware, software, a virtualised function instantiated on an appropriate platform (e.g. on a cloud infrastructure), or any combination of these.

While the invention has been shown and described with reference to certain examples, it will be understood by those skilled in the art that various changes in form and detail may be made therein without departing from the scope of the invention, as defined by the appended claims.

What is claimed is:

1. A method for deriving shared secret information between a first device (A) and a second device (B), the method comprising:
obtaining, by device A, a data set D_{A};
obtaining, by device B, a data set D_{B};
for each of N subsets, D_{A}ⁱ and D_{B}ⁱ, respectively of D_{A} and D_{B}(i=1, 2, . . . , N; N>1):
determining, by device A, a first value, V_{A}ⁱ=M_{A}(D_{A}ⁱ) based on D_{A}ⁱ, wherein M_{A} comprises an entropy-reducing function and/or a statistical function;
determining, by device B, a second value, V_{B}ⁱ=M_{B}(D_{B}ⁱ) based on D_{B}ⁱ, wherein M_{B} comprises an entropy-reducing function and/or a statistical function; and
exchanging one or more messages between devices A and B to determine whether a condition based on the first and second values, V_{A}ⁱ and V_{B}ⁱ, is satisfied;
obtaining, by device A, a reduced data set D_{A}′ based on those subsets D_{A}ⁱ for which the condition is satisfied; and
obtaining, by device B, a reduced data set D_{B}′ based on those subsets D_{B}ⁱ for which the condition is satisfied.

2. A method according to claim 1, further comprising:
repeating the steps of determining, exchanging and obtaining a reduced data set one or more times until one or more termination criteria are satisfied,
wherein the data sets used in one iteration comprise the reduced data sets obtained in the preceding iteration.

3. A method according to claim 2, wherein the one or more termination criteria comprise: the number of iterations has reached a predetermined threshold.

4. A method according to claim 1, wherein the data sets, D_{A} and D_{B}, each comprise data sequences (e.g. bit sequences).

5. A method according to claim 1, wherein the N subsets, D_{A}ⁱ and D_{B}ⁱ, each comprise mutually exclusive subsets of D_{A} and D_{B}, respectively.

6. A method according to claim 1, wherein the N subsets, D_{A}ⁱ and D_{B}ⁱ, each comprise a set of n (e.g. n=4) data elements (e.g. consecutive bits) of D_{A} and D_{B}, respectively.

7. A method according to claim 1, wherein M_{A} is the same function as M_{B}.

8. A method according to claim 1, wherein M_{A} and M_{B} comprise one or more of: parity function, Hamming distance function, mean function, and variance function.

9. A method according to claim 1, wherein exchanging the messages and determining whether the condition is satisfied comprise:
transmitting, by device A to device B, the first value, V_{A};
transmitting, by device B to device A, the second value, V_{B}; and
determining, by each of devices A and B, whether the condition is satisfied based on a comparison between the first and second values, V_{A} and V_{B}.

10. A method according to claim 1, wherein exchanging the messages and determining whether the condition is satisfied comprise:
transmitting, by one of the devices A and B (device X) to the other one of the devices A and B (device Y), the value V_{X};
comparing, by device Y, the values V_{X} and V_{Y}; and
transmitting, by device Y to device X, a message indicating the result of the comparison.

11. A method according to claim 1, wherein obtaining the reduced data set, D_{A}′, comprises:
for each subset, D_{X}ⁱ, for which the condition is satisfied, obtaining a corresponding subset, D_{X}ⁱ′, based on D_{X}ⁱ; and
combining the corresponding subsets, D_{X}ⁱ′, to generate the reduced data set, D_{X}′.

12. A method according to claim 11, wherein a corresponding subset, D_{X}ⁱ′, comprises one of:
all elements of D_{X}ⁱ;
a predetermined subset of elements of D_{X}ⁱ;
a function, S, of all elements of D_{X}ⁱ; and
a function, S, of a predetermined subset of elements of D_{X}ⁱ.

13. A method according to claim 12, wherein the function, S, comprises a parity function.

14. A method according to claim 1, wherein the data sets D_{A} and D_{B} each comprise a random data set.

15. A computer program comprising instructions which, when the program is executed by a computer or processor, cause the computer or processor to carry out a method according to claim 1.

16. A computer or processor-readable data carrier having stored thereon a computer program according to claim 15.
